(19) United States
(12) Patent Application Publication
(10) Pub. No.: US 2003/0005039 A1
(43) Pub. Date: Jan. 2, 2003

(54) End node partitioning using local identifiers

(75) Inventors: David F. Craddock, New Paltz, NY (US); David Arlen Elko, Austin, TX (US); Thomas Anthony Gregg, Highland, NY (US); Gregory Francis Pfister, Austin, TX (US); Renato John Recio, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/895,233

(22) Filed: Jun. 29, 2001

(51) Int. Cl. G06F 15/16

(52) U.S. Cl. 709/203

(57) ABSTRACT

A method and system for a distributed computing system having components like end nodes, switches, routers and links interconnecting packets over the interconnecting links. The switches and routers interconnect the end nodes and route the packets to the appropriate end node. The end nodes reassemble the packets into a message at a destination. A mechanism is provided to allow a single physical component to appear as multiple components each with unique control levels. These components may be host channel adapters (HCAs), target channel adapters (TCAs) or switches. A method and system for end node partitioning for a physical element is provided. A configuration of the physical element is selected. A port associated with the physical element is probed, wherein the port is probed with a subnet management packet by a subnet manager. In response to detecting a switch associated with the port, a local identifier is assigned to the port resulting in a configuration change of the physical element.

### BACKGROUND OF THE INVENTION

1. Technical Field

The present invention relates generally to communications between computer systems and, more particularly, to a method and apparatus the present invention is directed to supporting end node partitioning by virtualizing an InfiniBand channel adapter and switch components.

2. Description of Related Art

In a System Area Network (SAN), the hardware provides a message passing mechanism which can be used for Input/Output devices (I/O) and interprocess communications between general computing nodes (IPC). Consumers access SAN message passing hardware by posting send/receive messages to send/receive work queues on a SAN channel adapter (CA). The send/receive work queues (WQ) are assigned to a consumer as a queue pair (QP). The messages can be sent over five different defined transport types: Reliable Connected (RC), Reliable datagram (RD), Unreliable Connected (UC), Unreliable Datagram (UD), and Raw Datagram (RawD). In addition there is a set of manufacturer definable operation codes that allow for different companies to define custom packets that still have the same routing header layouts. Consumers retrieve the results of the defined messages from a completion queue (CQ) through SAN send and receive work completions (WC). The manufacturer definable operations are not defined as to whether or not they use the same queuing structure as the defined packet types. Regardless of the packet type, the source channel adapter takes care of segmenting outbound messages and sending them to the destination. The destination channel adapter takes care of reassembling inbound messages and placing them in the memory space designated by the destination's consumer. Two channel adapter types are present, a host channel adapter (HCA) and a target channel adapter (TCA). The host channel adapter is used by general purpose computing nodes to access the SAN fabric. Consumers use SAN verbs to access host channel adapter functions. The software that interprets verbs and directly accesses the channel adapter is known as the channel interface (CI).

InfiniBand components are assigned a Local Identifier (LID) during initialization. The LID is used to address a component within a subnet. All InfiniBand packets contain a Source LID and a Destination LID defining the packet's Source and Destination address within the subnet. InfiniBand components are also assigned at least one Partition Key (P_Key). The P_Key is used to partition an InfiniBand fabric into one or more groups. InfiniBand components are then placed into one or more of the groups. All other communications are allowed. The end nodes are grouped into partitions and access is controlled through the P_Key. The InfiniBand partitioning mechanism essentially allows hosts to provide adapters and shared adapters in a controlled manner.

However, InfiniBand does not provide a mechanism for partitioning an end node so that multiple operating system instances that share a single channel adapter port while at the same time gain controlled access to an InfiniBand subnet. Prior art systems typically add extra packet header or headers to identify the operating system instance. By adding packet header or headers this results in more complexity to data transmission. Therefore, this lack of a mechanism for partitioning an end node presents a problem for higher end servers which support partitioning in their processing and memory resources through logical or physical partitioning.

Therefore, a mechanism is needed to allow a single physical component to appear as multiple components with each single component having unique access control levels. The components may be host channel adapters (HCAs), target channel adapters (TCAs) or switches.

### SUMMARY OF THE INVENTION

A method and system for end node partitioning for a physical element is provided. A configuration of the physical element is selected. A port associated with the physical element is probed, wherein the port is probed with a subnet management packet by a subnet manager. In response to detecting a switch associated with the port, a local identifier is assigned to the port resulting in a configuration change of the physical element.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram of a network computing system in accordance with a preferred embodiment of the present invention;

FIG. 2 depicts a functional block diagram of a host processor node in accordance with a preferred embodiment of the present invention;

FIG. 3 depicts a diagram of a host channel adapter in accordance with a preferred embodiment of the present invention;

FIG. 4 depicts a diagram illustrating processing of work requests in accordance with a preferred embodiment of the present invention;

FIG. 5 depicts an illustration of a data packet in accordance with a preferred embodiment of the present invention;

FIG. 6 depicts a diagram of a physical component with virtual channel adapters and virtual switches in accordance with an embodiment of the present invention;

FIG. 7 is an exemplary flowchart illustrating an operation for a static selection system for a configuration of a physical element in accordance with a preferred embodiment of the present invention;

FIG. 8 is an exemplary flowchart illustrating reporting of host channel adapters and associated nodes as they become operational or are removed from operation in accordance with a preferred embodiment of the present invention; and

FIG. 9 is an exemplary flowchart illustrating an operation for a dynamic selection system for a configuration of a physical element in accordance with a preferred embodiment of the present invention.

### DETAILED DESCRIPTION OF THE PREFERRED EMBODIMENT

The present invention provides a network computing system having end nodes, switches, routers, and links interconnecting these components. The end nodes segment the message into packets and transmit the packets over the links. The switches and routers interconnect the end nodes and route the packets to the appropriate end node. The end nodes reassemble the packets into a message at the destination.

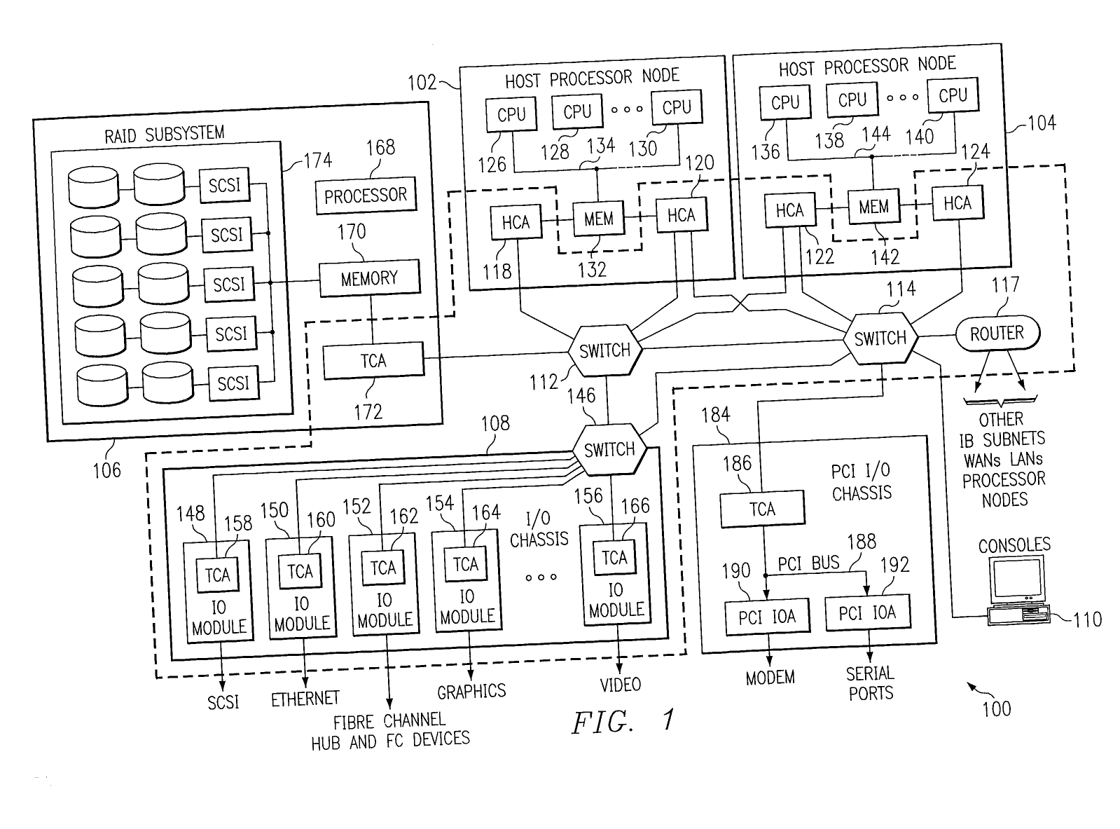

With reference now to the figures and in particular with reference to FIG. 1, a diagram of a network computing system is illustrated in accordance with a preferred embodiment of the present invention. The network computing system represented in FIG. 1 takes the form of a system area network (SAN) 100 and is provided merely for illustrative purposes, and the embodiments of the present invention described below can be implemented on computer systems of numerous other types and configurations.

SAN 100 is a high-bandwidth, low-latency network interconnecting nodes within the network computing system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, I/O chassis node 108, and PCI I/O Chassis node 184. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or frames in SAN 100.

A message, as used herein, is an application-defined unit of data exchange, which is a primitive unit of communication between cooperating processes. A packet is one unit of data encapsulated by a networking protocol headers and/or trailer. The headers generally provide control and routing information for directing the frame through SAN. The trailer generally contains control and cyclic redundancy check (CRC) data for ensuring packets are not delivered with corrupted contents.

SAN 100 contains the communications and management infrastructure supporting both I/O and interprocessor communications (IPC) within a network computing system. The SAN 100 shown in FIG. 1 includes a switched communications fabric 100, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, RAID I/O subsystem 106, I/O chassis 108, and PCI I/O Chassis 184 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144. Host channel adapter 118 provides a connection to switch 112, host channel adapters 120 and 122 provide a connection to switches 112 and 114, and host channel adapter 124 provides a connection to switch 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the network computing system with zero processor-copy data transfers without involving the operating system kernel process, and employs hardware to provide reliable, fault tolerant communications. As indicated in FIG. 1, router 117 is coupled to wide area network (WAN) and/or local area network (LAN) connections to other hosts or other routers.

The I/O chassis 108 in FIG. 1 includes a switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

PCI I/O Chassis node 184 includes a TCA 186 and multiple PCI Input/Output Adapters (IOA) 190-192 connected to TCA 186 via PCI bus 188. In these examples, the IOAs take the form of adapter cards. Example adapter cards illustrated in FIG. 1 include a modem adapter card 190 and serial adapter card 192. TCA 186 encapsulates PCI transaction requests or responses received from PCI IOAs 190-192 into data packets for transmission across the SAN fabric 100 to an HCA, such as HCA 118. HCA 118 determines whether received data packets contain PCI transmissions and, if so, decodes the data packet to retrieve the encapsulated PCI transaction request or response, such as a DMA write or read operation. HCA 118 sends it to the appropriate unit, such as memory 132. If the PCI transaction was a DMA read request, the HCA then receives the response from the memory, such as memory 132, encapsulates the PCI response into a data packet, and sends the data packet back to the requesting TCA 186 across the SAN fabric 100. the TCA then decodes the PCI transaction from the data packet and sends the PCI transaction to PCI IOA 190 or 192 across PCI bus 188.

Similarly, store and load requests from a processor, such as, for example, CPU 126, to a PCI IOA, such as PCI IOA 190 or 192 are encapsulated into a data packet by the HCA 118 for transmission to the TCA 186 corresponding to the appropriate PCI IOA 190 or 192 across SAN fabric 100. The TCA 186 decodes the data packet to retrieve the PCI transmission and transmits the PCI store or load request and data to PCI IOA 190 or 192 via PCI bus 188. If the request is a load request, the TCA 186 then receives a response from the PCI IOA 190 or 192 which the TCA encapsulates into a data packet and transmits over the SAN fabric 100 to HCA 118 which decodes the data packet to retrieve the PCI data and commands and sends the PCI data and commands to the requesting CPU 126. Thus, PCI adapters may be connected to the SAN fabric 100 of the present invention.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in network computing system. With an I/O adapter attached to the SAN 100, the resulting I/O adapter node has substantially the same communication capability as any host processor node in SAN 100.

FIG. 1 is intended as an example, and not as an architectural limitation for the present invention and is provided merely for illustrative purposes. The embodiments of the present invention, as described below, may be implemented on computer systems of numerous types and configurations. For example, computer systems implementing the present invention may range from a small server with one processor and a limited number of input/output (I/O) adapters to a massive parallel supercomputer system or systems with, for example, hundreds of processor and thousands of I/O adapters. Furthermore, the present invention may be implemented in an infrastructure of remote computer systems connected by, for example, an internet or an intranet.

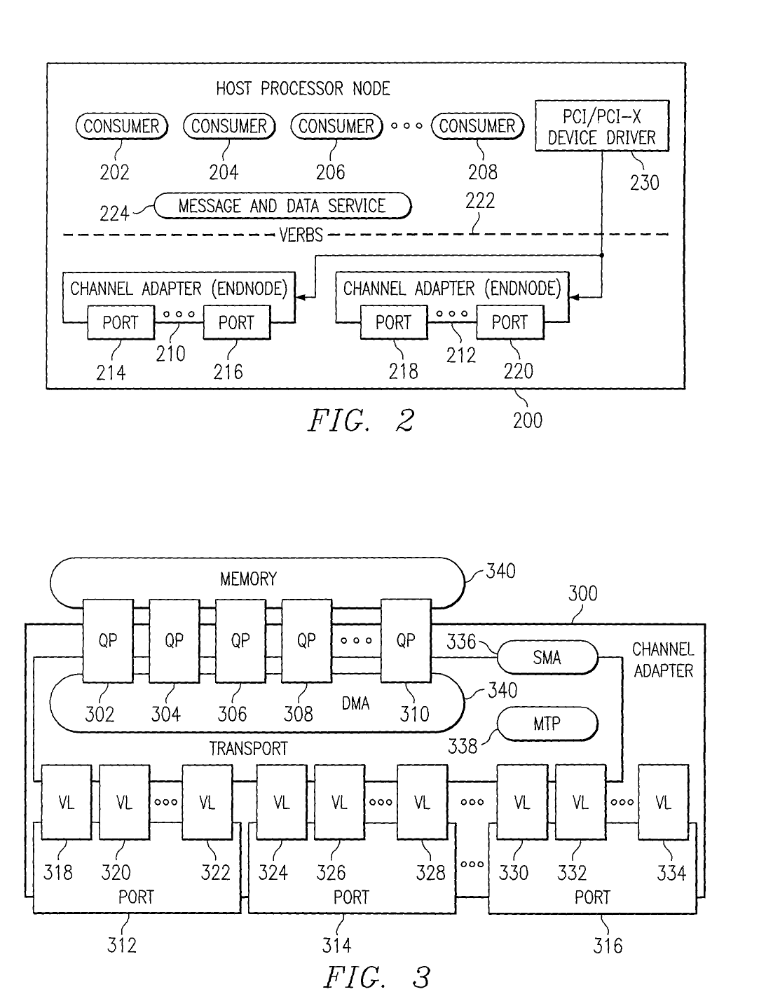

FIG. 2 depicts a functional block diagram of a host processor node in accordance with a preferred embodiment of the present invention. Host processor node 200 is an example of a host processor node, such as host processor node 102 in FIG. 1.

In this example, host processor node 200 shown in FIG. 2 includes a set of consumers 202-208 and one or more PCI/PCI-X device drivers 230, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher level interface than the verb layer and is used to process messages and data received through channel adapter 210 and channel adapter 212. Message and data service 224 provides an interface to consumers 202-208 to process messages and other data. In addition, the channel adapter 210 and channel adapter 212 may receive load and store instructions from the processors which are targeted for PCI IOAs attached to the SAN. These bypass the verb layer, as shown in FIG. 2.

FIG. 3 depicts a diagram of a host channel adapter in accordance with a preferred embodiment of the present invention. Host channel adapter 300 shown in FIG. 3 includes a set of queue pairs (QPs) 302-310, which are one means used to transfer messages to the host channel adapter ports 312-316. Buffering of data to host channel adapter ports 312-316 is channeled through virtual lanes (VL) 318-334 where each VL has its own flow control. Subnet manager configures channel adapters with the local addresses for each physical port, i.e., the port's LID. Subnet manager agent (SMA) 336 is the entity that communicates with the subnet manager for the purpose of configuring the channel adapter. Memory translation and protection (MTP) 338 is a mechanism that translates virtual addresses to physical addresses and to validate access rights. Direct memory access (DMA) 340 provides for direct memory access operations using memory 340 with respect to queue pairs 302-310.

A single channel adapter, such as the host channel adapter 300 shown in FIG. 3, can support thousands of queue pairs. By contrast, a target channel adapter in an I/O adapter typically supports a much smaller number of queue pairs.

Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

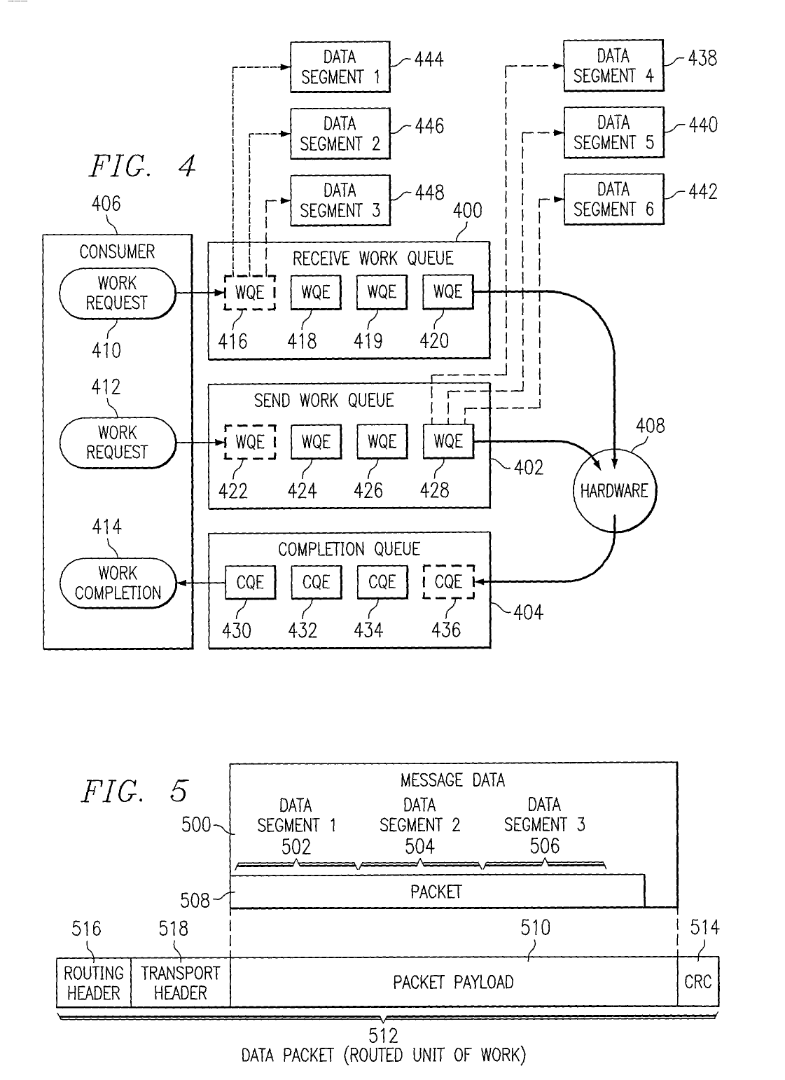

FIG. 4 depicts a diagram illustrating processing of work requests in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses which have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. For example, work queue element 416 in receive work queue 400 references data segment 1 444, data segment 2 446, and data segment 448. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal.

A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a network computing system implementing the present invention supports four types of transport services.

Reliable and Unreliable connected services associate a local queue pair with one and only one remote queue pair. Connected services require a process to create a queue pair for each process which is to communicate with over the SAN fabric. Thus, if each of N host processor nodes contain P processes, and all P processes on each node wish to communicate with all the processes on all the other nodes, each host processor node requires P²×(N−1) queue pairs. Moreover, a process can connect a queue pair to another queue pair on the same host channel adapter.

Reliable datagram service associates a local end-end (EE) context with one and only one remote end-end context. The reliable datagram service permits a client process of one queue pair to communicate with any other queue pair on any other remote node. At a receive work queue, the reliable datagram service permits incoming messages from any send work queue on any other remote node. The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

The unreliable datagram service is connectionless. The unreliable datagram service is employed by management applications to discover and integrate new switches, routers, and endnodes into a given network computing system. The unreliable datagram service does not provide the reliability guarantees of the reliable connection service and the reliable datagram service. The unreliable datagram service accordingly operates with less state information maintained at each endnode.

FIG. 5 is an illustration of a data packet in accordance with a preferred embodiment of the present invention. Message data 500 contains data segment 1 502, data segment 2 504, and data segment 3 506, which are similar to the data segments illustrated in FIG. 4. In this example, these data segments form a packet 508, which is placed into packet payload 510 within data packet 512. Additionally, data packet 512 contains CRC 514, which is used for error checking. Additionally, routing header 516 and transport 518 are present in data packet 512. Routing header 516 is used to identify source and destination ports for data packet 512. Transport header 518 in this example specifies the destination queue pair for data packet 512. Additionally, transport header 518 also provides information such as the operation code, packet sequence number, and partition for data packet 512. The operating code identifies whether the packet is the first, last, intermediate, or only packet of a message. The operation code also specifies whether the operation is a send RDMA write, read, or atomic. The packet sequence number is initialized when communications is established and increments each time a queue pair creates a new packet. Ports of an endnode may be configured to be members of one or more possibly overlapping sets called partitions.

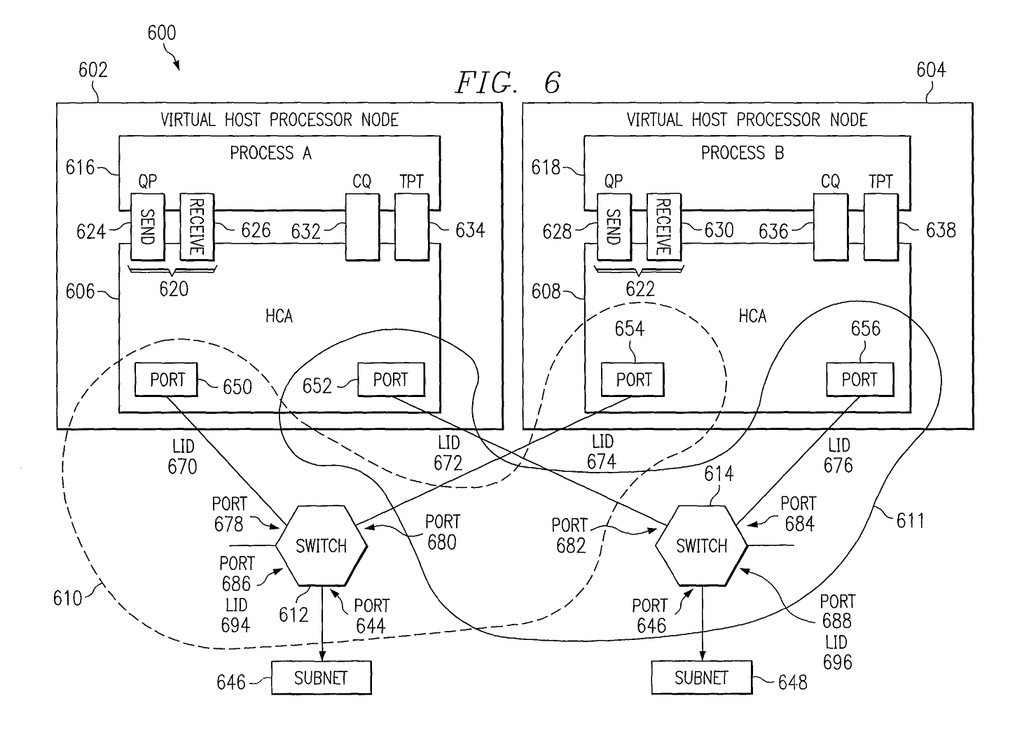

FIG. 6 depicts a diagram of a physical component with virtual channel adapters and virtual switches in accordance with an embodiment of the present invention. FIG. 6 illustrates an internal structure of a multi-function chip containing one or more switches interconnecting one or more HCAs to one or more subnets. Physical element 600 in FIG. 6 includes virtual host processor node 602 and virtual host processor node 604. Virtual host processor node 602 includes virtual host channel adapter (HCA) 606. Virtual host processor node 604 includes host channel adapter (HCA) 608. Virtual HCAs 606 and 608 may have the same attributes as a physical HCA. For example, virtual HCAs 606 and 608, in this example, have mandatory queue pair numbers 0 and 1.

Physical element 600 in FIG. 6 includes SAN fabric 610 which includes switch 612. SAN fabric 610 in FIG. 6 includes a link coupling host channel adapter 606 to switch 612 and a link coupling switch 612 to TCA 642. Network computing system 600 in FIG. 6 also includes a SAN fabric 611 which includes switch 614. SAN fabric 611 in FIG. 6 includes a link coupling host channel adapter 608 to switch 614 and a link coupling switch 614 to TCA 644. Virtual HCA 606 includes port 650 and 652. Port 650 connects to subnet 646 through port 678 of switch 612. Port 652 attaches to subnet 648 through port 682 of switch 614. A subnet manager associated with subnet 646 has assigned LID 670 to port 650 of HCA 606 and LID 694 to port 686 of switch 612. Port 686 is the InfiniBand Subnet Management Port 0 for switch 612. A subnet manager is associated with subnet 648 which has assigned LID 672 to port 652 of HCA 606 and LID 696 to port 688 of switch 614. Port 688 is the InfiniBand Subnet Management Port 0 for switch 614. Virtual HCA 608 includes ports 654 and 656. Port 654 is connected to subnet 646 through port 680 of switch 612. Port 656 attaches to subnet 648 through port 684 of switch 614. A subnet manager associated with subnet 646 has assigned LID 674 to port 654 of HCA 608. A subnet associated with subnet 648 has assigned LID 676 to port 656 of HCA 608.

In the example transactions, host processor node 602 includes client process A 616. Host processor node 604 includes a client process B 618. Client process A 616 interacts with host channel adapter hardware 606 through queue pair 620, completion queue 632 and Translation Protection Table (TPT) 634. Client process B 618 interacts with host channel adapter 608 through queue pair 622, completion queue 636 and TPT 638. Queue pair 620 queue pair 622, completion queue 632, completion queue 636, TPT 634 and TPT 638 are data structures. Queue pair 620 includes a send work queue 624 and a receive work queue 626. Queue pair 622 includes a send work queue 628 and a receive work queue 630. Completion queues 632 and 636 consist of a single completion queue. TPTs 634 and 638 consist of a memory consists of a memory address translation and protection table.

A channel adapter, for example a TCA or a HCA, may provide a resource configuration and allocation interface to software, firmware or a hardware state machine which will execute as part of physical element 600. The resource configuration and allocation interface allows software, firmware, or hardware state machines to set an operating policy for the virtual HCA, for example HCAs 606 and 608 in FIG. 6. The operating policy may include:

1) number of switches used within a multi-function chip;

2) number of ports per switch;

3) number of switch resources allocated to each switch;

4) number of HCAs used within the multi-function chip;

5) number of ports per HCA; and

6) number of HCA resources allocated to each HCA.

Software, firmware or a hardware state machine may select the actual configuration of physical element 600. A physcial element may be, for example, an HCA. The selection may be static or dynamic. A static selection may require a HCA or a switch configuration to be changed through re-initialization of a fabric and/or a reboot of a node. A dynamic selection allows a HCA or switch configuration change to be made without fabric re-initialization, but may require a boot of the node.

Under a static selection mechanism, physical element 600 may have to report an exact number of virtual switches, HCAs, and host processor nodes that may be included as part of physical element 600 during fabric initialization. A static selection mechanism may provide information whether there are any ports available on the physical element but does not provide information regarding port status without a request for the information. Using a static selection mechanism, each virtual HCA may appear as a distinct, physical HCA. In FIG. 6, a subnet manager associated with subnet 646 detects switch 612 as a result of probing port 644 with standard InfiniBand subnet management packets (SMPs). Switch 612 appears as a physical switch to the subnet manager associated with subnet 646 and is assigned LID 694 to its SMP port 686. The subnet manager associated with subnet 646 identifies that switch 612 has two additional ports, ports 678 and 680, through InfiniBand SMPs. The subnet manager associated with subnet 646 detects HCA 606 as a result of using InfiniBand SMPs to probe switch 612 port 678 and locating HCA 606 port 650. HCA 606 appears as a physical HCA to the subnet manager associated with subnet 646. The subnet manager associated with subnet 646 assigns LID 670 to port 650 of HCA 606 using InfiniBand SMPs. Similarly, the subnet manager associated with subnet 646 detects HCA 608 as a result of using InfiniBand SMPs. HCA 608 appears as a physical HCA to the subnet manager associated with subnet 646. The subnet manager associated with subnet 646 assigns LID 674 to port 654 using InfiniBand SMPs.

Using a dynamic selection mechanism, physical element 600 may report to the largest configurable number of virtual switches and their corresponding topology, but may not report the exact number of HCAs and host processor nodes that may be included as part of physical element 600 during fabric initialization. A dynamic selection mechanism may provide information whether there are any ports available on the physical element and may provide information when a previously unavailable port becomes operational. Similarly, a dynamic selection mechanism may report removal of HCAs and their associated host nodes, as they are removed from operation. Using a dynamic selection mechanism, each virtual HCA may appear as a distinct, physical HCA.

In FIG. 6, if HCA 606 becomes operational at a later point in time, then the following process may take place. A subnet manager associated with subnet 646 detects switch 612 as a result of probing port 644 with InfiniBand management packets (SMPs). Switch 612 appears as a physical switch to the subnet manager associated with subnet 646 and is assigned LID 694 to its SMP port 686. The subnet manager associated with subnet 646 identifies that switch 612 has two additional ports, ports 678 and 680, through standard InfiniBand SMPs. The subnet manager associated with subnet 646 detects HCA 606 as a result of using InfiniBand SMPs to probe switch 612, port 678 and locating HCA 606 port 650. HCA 606 appears as a physical HCA to the subnet manager associated with subnet 646. The subnet manager associated with subnet 646 assigns LID 670 to port 650 of HCA using InfiniBand SMPs. At a later point in time, the subnet manager associated with subnet 646 may detect HCA 608 as a result of a SMP sweep by a subnet manager associated with subnet 646 to probe switch 612, port 680 and locating HCA 608 port 654.

Alternatively, the subnet manager associated with subnet 646 may detect HCA 608 as a result of a trap from switch 612 indicating a state change. This would cause the subnet manager associated with subnet 646 to use InfiniBand SMPs to probe switch 612, port 680 and locate HCA 608 port 654. HCA 608 appears as a physical HCA to the subnet manager associated with subnet 646. The subnet manager associated with subnet 646 assigns LID 674 to port 654 of HCA 608 using InfiniBand SMPs.

As mentioned above, the present invention provides a method and system for end node partitioning for a physical element. Selection of a configuration of the physical element may be static or dynamic. With a static selection mechanism, a subnet manager may probe the physical element, such as, for example, a switch or HCA, to determine if the physical element is detected. If the physical element is detected then a LID is assigned to the physical element's SMP port. If additional ports are detected for the physical element a LID is assigned to the additional ports.

With a dynamic selection mechanism, HCAs and the HCA's associated host nodes will be reported as they become operational. In addition, the dynamic selection mechanism reports removal of the HCAs and the HCA's associated host nodes as the HCA and the HCA's associated host nodes are removed from operation. When a HCA becomes operational a subnet manager assigns a LID to a port associated with the HCA.

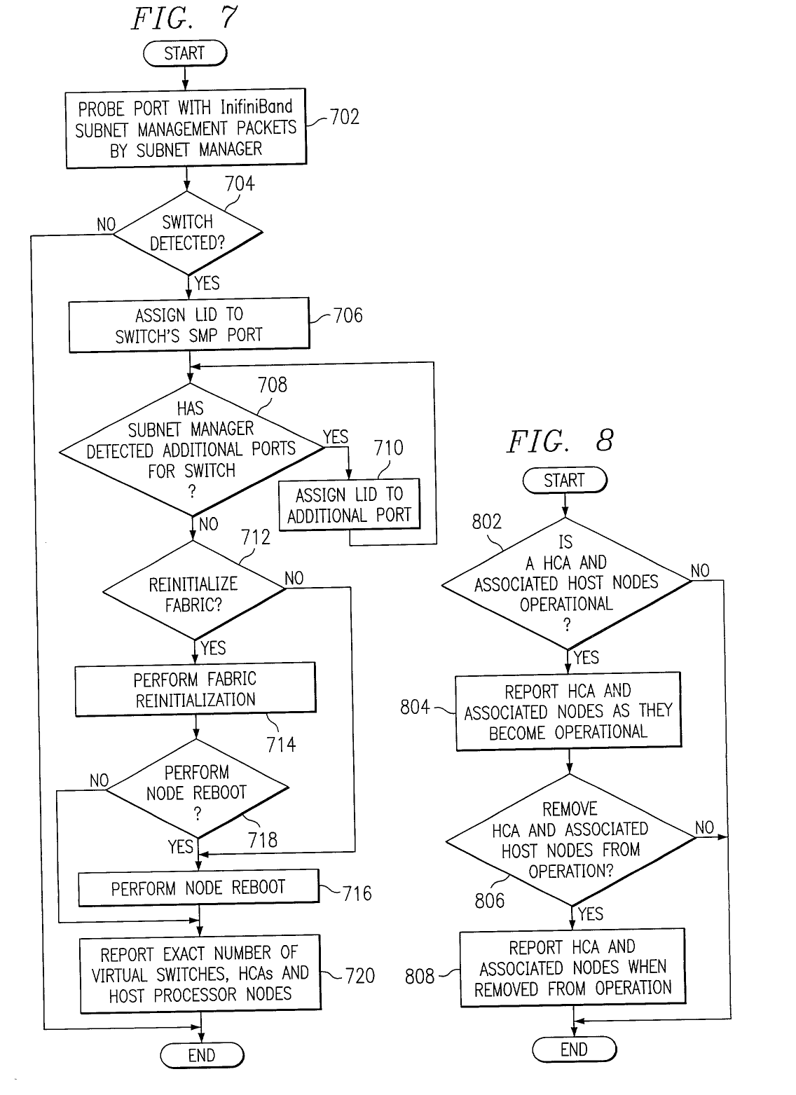

FIG. 7 is an exemplary flowchart illustrating an operation for a static selection system for a configuration of a physical element in accordance with a preferred embodiment of the present invention. In this example the operation starts by probing a port with InfiniBand subnet management packets by a subnet manager (step 702). A determination is made as to whether or not a switch is detected in response to the probing of the port with the InfiniBand subnet management packets by the subnet manager (step 704). If a switch is not detected (step 704: NO), the operation terminates. If a switch is detected (step 704: YES), then a LID is assigned to the switch's SMP port (step 706).

A determination is then made as to whether or not the subnet manager has detected additional ports for the switch (step 708). If the subnet manager has detected additional port(s) for the switch (step 708: YES), then an LID is assigned to the additional port(s) (step 710) and the operation returns to step 708 in which a determination is made as to whether or not the subnet manager has detected additional ports for the switch. If the subnet manager has not detected additional ports for the switch (step 708: NO), then a determination is made as to whether or not fabric is to be reinitialized (step 712). If the fabric is not to be reinitialized (step 712: NO), a node reboot is performed (step 716). The exact number of virtual switches, HCAs and host processor nodes are then reported to a subnet manager (step 720), and thereafter the operation terminates. If the fabric is to be reinitialized (step 712: YES), the fabric reinitialization is performed (step 714). A determination is then made as to whether or not a node reboot is to be performed (step 718). If a node reboot is to be performed (step 718: YES), the node reboot is performed (step 716) and the exact number of virtual switches, HCAs and host processor nodes are reported (step 720) and thereafter the operation terminates. If node reboot is not to be performed (step 718: NO), the exact number of virtual switches, HCAs and host processor nodes are reported (step 720) and thereafter the operation terminates.

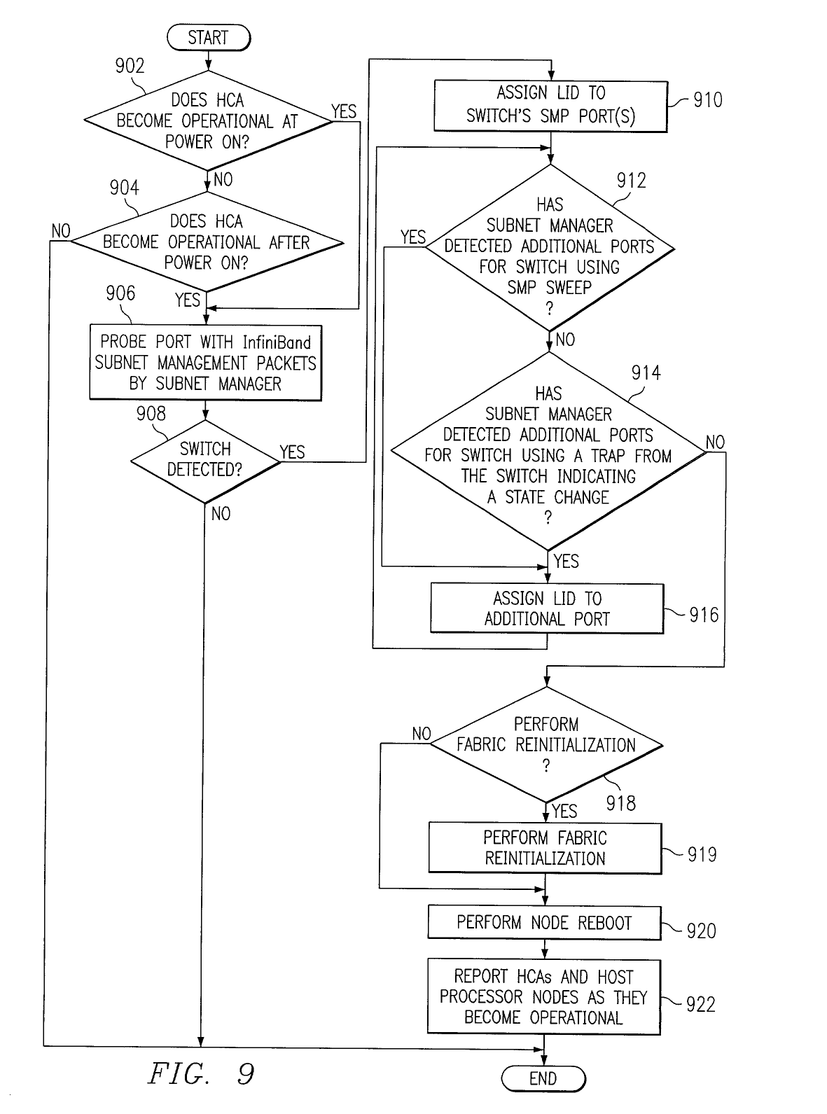

FIG. 8 is an exemplary flowchart illustrating reporting of host channel adapters and associated nodes as they become operational or are removed from operation in accordance with a preferred embodiment of the present invention. In this example, the operation starts by determining whether or not a HCA and the HCA's associated host nodes are operational (step 802). If the HCA and the HCA's associated host nodes are not operational (step 802: NO), the operation terminates. If the HCA and the HCA's associated host nodes are operational (step 802: YES), then the HCA and associated nodes are reported as they become operational to a subnet manager (step 804). A determination is then made as to whether or not the HCA and the HCA's associated host nodes have been removed from operation (step 806). If the HCA and the HCA's associated host nodes have not been removed from operation (step 806: NO), the operation terminates. If the HCA and the HCA's associated host nodes have been removed from operation (step 806: YES), the HCA and the HCA's ssociated nodes are reported to be removed from operation (step 808), and thereafter the operation terminates.

FIG. 9 is an exemplary flowchart illustrating an operation for a dynamic selection system for a configuration of a physical element in accordance with a preferred embodiment of the present invention. In this example, the operation starts by a determination as to whether or not a HCA becomes operational at a power on condition (step 902). If a HCA does not become operational at a power on condition (step 902: NO), a determination is made as to whether or not a HCA becomes operational after a power on condition (step 904). If a HCA does not become operational after a power on condition (step 904: NO), the operation terminates. If a HCA does become operational after a power on condition (step 904: YES), the operation continues to step 906 in which a port is probed with InfiniBand subnet management packets by a subnet manager.

Returning to step 902, if an HCA does become operational at a power on condition (step 902: YES), a port is probed with InfiniBand subnet management packets by a subnet manager (step 906). A determination is made as to whether or not a switch is detected (step 908). If a switch is not detected (step 908: NO), the operation terminates. If a switch is detected (step 908: YES), a LID is assigned to the switch's SMP port (step 910). A determination is then made as to whether or not a subnet manager has detected additional ports for the switch using a SMP sweep (step 912). If a subnet manager has detected additional ports for the switch using a SMP sweep (step 912: YES), a LID is assigned to the additional port and the operation continues to step 914 in which a determination is made as to whether or not the subnet manager has detected additional ports for the switch using a trap from the switch indicating a state change.

If the subnet manager has not detected additional ports for the switch using a SMP sweep (step 912: NO), a determination is then made as to whether or not the subnet manager has detected additional ports for the switch using a trap from the switch indicating a state change (step 914). If the subnet manager has detected additional ports for the switch using a trap from the switch indicating a state change (step 914: YES), and LID is assigned to the additional port (step 916) and the operation returns to step 912 in which a determination is made as to whether or not the subnet manager has detected additional ports for the switch using a SMP sweep.

If the subnet manager has not detected additional ports for the switch using a trap from the switch indicating a state change (step 914: NO), a determination is made as to whether or not fabric reinitialization is to be performed (step 918). If fabric reinitialization is to be performed (step 918: YES), the fabric initialization is performed and the operation continues to step 920 in which a node reboot is performed. If a fabric initialization is not to be performed (step 918: NO), then a node reboot is performed (step 920). HCAs and host processor nodes are reported as they become operational (step 922) and thereafter the operation terminates.

Therefore, the present invention provides for a mechanism to allow a single physical component to appear as multiple components with each single component having unique access control levels. The components may be host channel adapters (HCAs), target channel adapters (TCAs) or switches. Resources used to create the host channel adapters and switches may be obtained by a static or dynamic selection of software, firmware and state machine from a common pool. Allocation of these resources may be performed through various mechanisms. For example, a simple 1/N mechanism may be used to assign resources across all virtual HCAs. Alternatively, a weighted average mechanism may be used to create virtual HCAs with differing abilities, The resources may consist of, but are not limited to, all HCA and QP selectable modifiers. For example, these HCA and QP selectable modifiers may be a number of QPs, number of CQs, TPT size, P-Key table sizes, number of outstanding read RDMAs, and the like.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for end node partitioning for a physical element, comprising the steps of:
selecting a configuration of the physical element;
probing a port, wherein the port is probed with a subnet management packet by a subnet manager;
in response to detecting a switch associated with the port, assigning a local identifier to the port resulting in a configuration change of the physical element.

2. The method as recited in claim 1, wherein selecting the configuration of the physical element includes a static selection of the physical element and a dynamic selection of the physical element.

3. The method as recited in claim 2, further comprising:
in response to a static selection of the physical element, modifying the configuration of the physical element through at least one of a fabric initialization and a reboot of a node associated with the port.

4. The method as recited in claim 2, further comprising:
in response to a dynamic selection of the physical element, modifying the configuration of the physical element through a reboot of a node associated with the port.

5. The method as recited in claim 1, further comprising:
in response to determining an additional port associated with the switch, assigning a local identifier to the additional port.

6. The method as recited in claim 1, further comprising:
in response to a host channel adapter and a host node becoming operational, reporting the host channel adapters and host processor node as they become operational.

7. The method as recited in claim 1, further comprising:
in response to removing a host channel adapter and a host node from operation, reporting the removal of the host channel adapter and the host node from operation.

8. The method as recited in claim 1, further comprising:
connecting one or more operating system images to at least one host channel adapter.

9. The method as recited in claim 8, wherein the host channel adapter is a virtual host channel adapter.

10. A physical element, comprising:
at least one switch; and
at least one host channel adapter functionally connected to the at least one switch.

11. The physical element as recited in claim 10, wherein the at least one switch is at least one virtual switch.

12. The physical element as recited in claim 10, wherein the at least one host channel adapter is at least one virtual channel adapter.

13. A system for end node partitioning for a physical element, comprising:
a selection component for selecting a configuration of the physical element;
a probing component for probing a port, wherein the port is probed with a subnet management packet by a subnet manager;
an assignment component, in response to detecting a switch associated with the port, for assigning a local identifier to the port resulting in a configuration change of the physical element.

14. The system as recited in claim 13, wherein selecting the configuration of the physical element includes a static selection of the physical element and a dynamic selection of the physical element.

15. The system as recited in claim 14, further comprising:
a modification component, in response to a static selection of the physical element, for modifying the configuration of the physical element through at least one of a fabric initialization and a reboot of a node associated with the port.

16. The system as recited in claim 14, further comprising:
a modification component, in response to a static selection of the physical element, for modifying the configuration of the physical element through at least one of a fabric initialization and a reboot of a node associated with the port.

17. The system as recited in claim 13, further comprising:
the assignment component, in response to determining an additional port associated with the switch, assigns a local identifier to the additional port.

18. The system as recited in claim 13, further comprising:
a reporting component, in response to a host channel adapter and a host node becoming operational, for reporting the host channel adapter and host processor node as they become operational.

19. The system as recited in claim 13, further comprising:
a reporting component, in response to removing a host channel adapter and a host node from operation, reporting the removal of the host channel adapter and the host node from operation.

20. The system as recited in claim 13, further comprising:
a connection component for connecting one or more operating system images to at least one host channel adapter.

21. The system as recited in claim 20, wherein the host channel adapter is a virtual host channel adapter.

22. A computer program product in a computer readable medium for end node partitioning for a physical element, comprising:
instructions for selecting a configuration of the physical element;
instructions for probing a port, wherein the port is probed with a subnet management packet by a subnet manager;
instructions, in response to detecting a switch associated with the port, for assigning a local identifier to the port resulting in a configuration change of the physical element.

23. The computer program product as recited in claim 22, wherein selecting the configuration of the physical element includes a static selection of the physical element and a dynamic selection of the physical element.

24. The computer program product as recited in claim 23, further comprising:
instructions, in response to a static selection of the physical element, for modifying the configuration of the physical element through at least one of a fabric initialization and a reboot of a node associated with the port.

25. The computer program product as recited in claim 23, further comprising:
instructions, in response to a dynamic selection of the physical element, for modifying the configuration of the physical element through a reboot of a node associated with the port.

26. The computer program product as recited in claim 23, further comprising:
instructions, in response to determining an additional port associated with the switch, for assigning a local identifier to the additional port.

27. The computer program product as recited in claim 23, further comprising:
instructions, in response to a host channel adapter and a host node becoming operational, for eporting the host channel adapters and host processor node as they become operational.

28. The computer program product as recited in claim 23, further comprising:
Instructions, in response to removing a host channel adapter and a host node from operation, for reporting removal of the host channel adapter and the host node from operation.

29. The computer program product as recited in claim 23, further comprising:
Instructions for connecting one or more operating system images to at least one host channel adapter.

30. The computer program product as recited in claim 29, wherein the host channel adapter is a virtual host channel adapter.
